(19) United States
(12) Patent Application Publication
(10) Pub. No.: US 2009/0119782 A1
(43) Pub. Date: May 7, 2009

(54) METHOD AND DEVICE FOR DIGITAL RIGHTS PROTECTION

(75) Inventor: Eitan Mardiks, Raanana (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD., Kfar Saba (IL)

(21) Appl. No.: 11/936,103

(22) Filed: Nov. 7, 2007

(51) Int. Cl. G06F 21/24

(52) U.S. Cl. 726/27

(57) ABSTRACT

Data stored in a memory are provided to a host by monitoring how the host accesses the data, and by responding to a deviation of the access from a dynamic access profile that corresponds to the data, e.g. by terminating the access, by issuing a report of the deviation, or by sending spurious data to the host. Preferably, the dynamic access profile is stored in the memory in association with the data. A data storage device includes a memory for storing the data and an access control mechanism.

### FIELD AND BACKGROUND OF THE INVENTION

Herein are presented a method, device and system for digital rights protection and, more particularly, to a method, device and system for discouraging a user from copying digital data.

Methods by which owners of copyrighted digital data manage (“digital rights management”) and protect (“digital rights protection” access to their data are well-known in the art. Digital rights protection, as discussed herein, relates to protecting access to data stored in a storage device that is operationally installed or operationally connected to a computing system that is referred to herein as the “host” of the storage device. All known methods of digital rights protection require adjustment of the host to enable the use of the protected content. For example, the host might need to have special software installed in order to read the protected data.

### DEFINITIONS

An “access profile” is a set of restrictions on access (reading, writing, erasing) of data.

A “static” access profile restricts whether data may be read, written or erased. A “dynamic” access profile restricts how data may be read, written or erased. Common examples of static access profiles include marking data as “read only” and allowing only specified users to write data. The method, device and system presented herein are concerned with dynamic access profiles. Examples of dynamic access profiles include restrictions on how fast data are allowed to be read and in what sequence data are allowed to be read.

### SUMMARY OF THE INVENTION

As noted above, the specific field of the method, device and system presented herein is digital rights protection. The method presented herein may be integrated with any prior art method of digital rights management.

As noted above, all known methods of digital rights protection require adjustment of the host, of the data storage device wherein the data are stored, to enable the use of the protected content. The data storage device presented herein uses a digital rights protection method that does not require adjustment, adaptation or enhancement of the device's host.

There is presented herein a method of providing data stored in a memory to a host of the memory, including the steps of: (a) monitoring an access, by the host, of is data stored in the memory, the data having a dynamic access profile associated therewith; and (b) responding to a deviation of the access from the dynamic access profile.

Furthermore, there is presented herein a data storage device for providing data to a host, including: (a) a memory wherein the data are stored together with a corresponding data access profile; and (b) an access control mechanism for (i) monitoring an access by the host to the memory; and (ii) responding to a deviation of the access from the dynamic access profile.

The basic method presented herein is a method of providing data stored in a memory to a host of the memory. For example, the method could be used to provide data from a high capacity SIM card to a cellular telephone in which the high capacity SIM card is installed. Access of the data by the host is monitored. A deviation of the access from a dynamic access profile that corresponds to the data is responded to, e.g. by terminating the access. Alternatively or additionally, the response includes issuing a report of the deviation, for example issuing an error message to the host, or, e.g. if the host is a cellular telephone, sending a report in the form of an SMS message to a remote server. Alternatively or additionally, the response includes sending spurious data to the host instead of the requested real data.

Preferably, the method also includes the step of providing the access profile, usually by storing the access profile in the memory in association with the data. Most preferably, the providing of the access profile includes the step of learning a normal access pattern of the data. The access profile then is based on the normal access pattern. A “normal” access pattern is the manner in which an application program, for which the data is intended, accesses the data.

Preferably, the access profile includes a rate schedule of access of the data by the host. For example, the access of audiovisual data by a player application is expected to be slower than the access of the data by a copy application. As another example, the access of a database by a database application is expected to be sporadic, rather than continuous as by a copy application.

Also preferably, the access profile includes a sequence of access of the data by the host. For example, the access of a database by a database application is expected to be piecewise sequential, as opposed to the fully sequential access of a copy application.

Also preferably, the access profile includes an identity of the data, for example a list of (logical) block numbers to which access is allowed (thus directly identifying the data) or a list of (logical) block numbers to which access is not allowed (thus identifying the data by implication).

A basic data storage device, for providing data to a host, includes a memory wherein the data are stored and an access control mechanism for implementing the method presented herein, i.e., for monitoring an access by the host to the memory and for responding to a deviation of the access from an access profile that corresponds to the data. For example, in the case of the host being a cellular telephone, the data storage device could be a high capacity SIM card configured to implement the method provided herein. Other embodiments of the data storage device of the present invention include hard disk drives, and solid state drives such as flash disk drives.

Preferably, the data storage device also includes a standard interface to the host.

It is known to associate digital content, that is stored in a storage device, with a “throughput rate” that also is stored in the storage device. For example, the throughput rate could be used to limit the rate at which audiovisual content is presented to a host of the device. This, however, is quite different from the method and device presented herein, because the content always is presented to the host by the known storage device in accordance with the throughput rate, regardless of how the host accesses the content. The only monitoring of the access that that known storage device performs is relative to other parameter values that are stored in the known storage device for the purpose of securing access to the content, which parameter values constitute a “static” access profile as defined herein.

### BRIEF DESCRIPTION OF THE DRAWINGS

The method, device and system presented herein is described, by way of example only, with reference to the accompanying drawings, wherein:

FIG. 1 is a high-level schematic block diagram of a data storage device for digital rights protection;

FIG. 2 shows a data storage device for digital rights protection operationally coupled to a host thereof;

FIG. 3 is a generalized flowchart of a method of digital rights protection.

### DESCRIPTION OF THE PREFERRED EMBODIMENTS

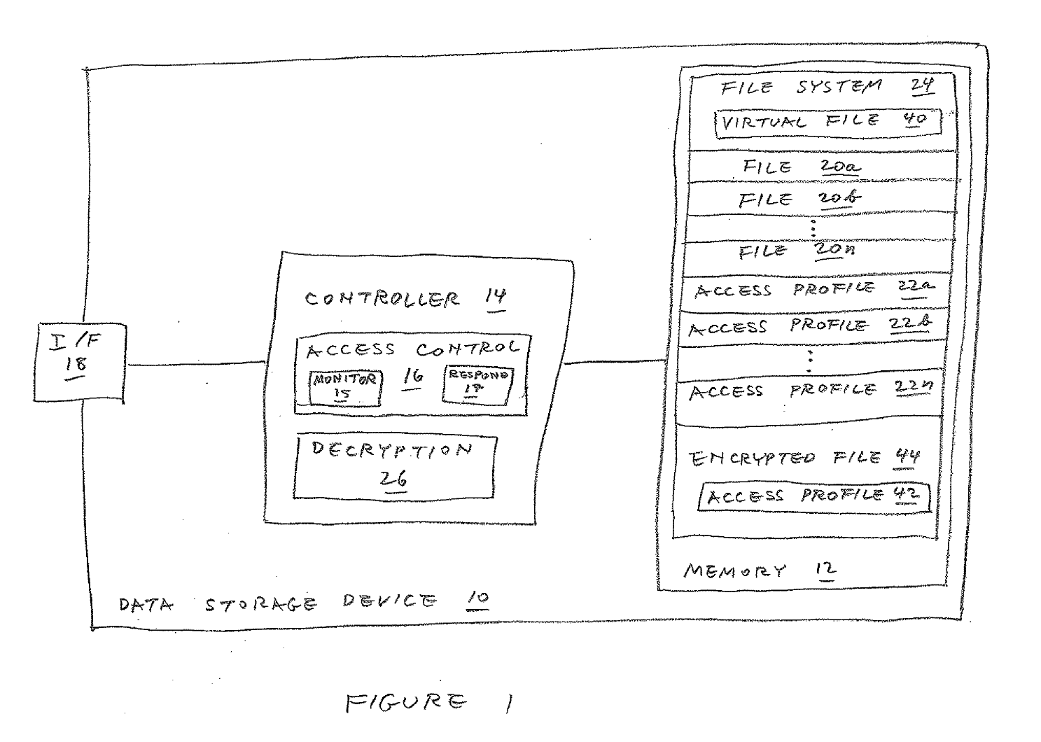

Referring now to the drawings, FIG. 1 is a high-level schematic block diagram of a data storage device 10. Data storage device 10 includes a nonvolatile memory 12, a controller 14 of memory 12 and an interface 18. Memory 12 may be any kind of nonvolatile memory but typically is a flash memory. In memory 12 are stored encrypted data files 20a through 20n and a conventional file system 24, such as the FAT file system of Microsoft or the NTFS file system of Microsoft, that describe how data files 20a through 20n are stored in memory 12. Controller 14 manages memory 12 in the conventional manner. For example, if memory 12 is a flash memory, controller 12 may operate, as is known in the prior art, to present memory 12 to a host of data storage device 10 as a block device. Controller 14 also includes decryption functionality 26 for decrypting files 20a through 20n and access control functionality 16 for controlling access of data files 20a through 20n by the host of data storage device 10 as described below.

Interface 18 is a standard interface for interfacing data storage device 10 with its host for exchange of data. By “standard” interface is meant an interface that complies with a commonly accepted industry standard and that lacks special provision for data rights protection. Common examples of such standards include SD, compact flash, MMC and USB.

For each file 20 a corresponding access profile 22 is stored in memory 12. Each access profile 22 describes limitations on how data storage device 10 presents data from that file 20 to the host of data storage device 10. These limitations are enforced by access control functionality 16 of controller 14. Examples of such limitations are described below. Access profiles 22a through 22n may be in the same partition of memory 12 as files 20a through 20n or alternatively may be in a separate partition of memory 12.

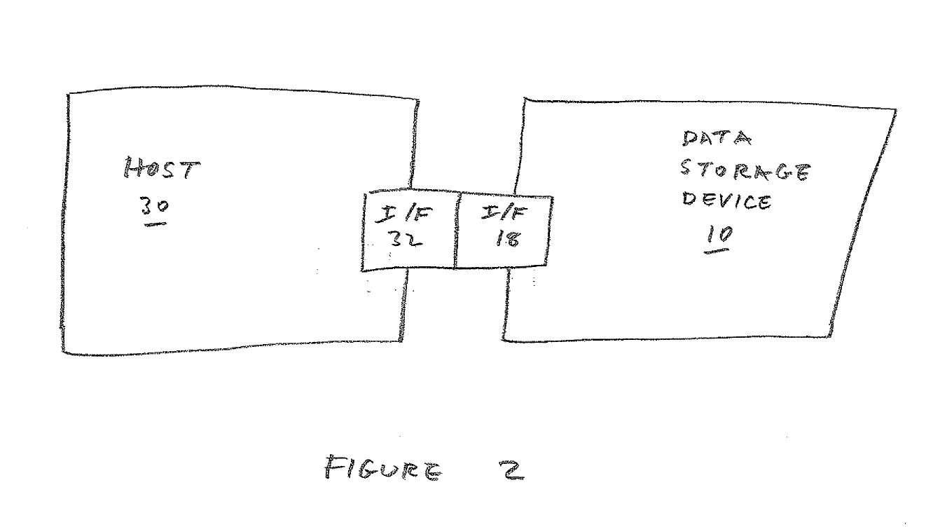

FIG. 2 shows data storage device 10 operationally connected to a host 30 via their respective interfaces 18 and 32. For example, interfaces 18 could be a standard USB plug and interface 32 could be a matching standard USB socket. It is important to note that that if the operating system of host 30 enables host 30 to be operationally coupled to a standard data storage device that lacks special data rights management/protection functionality, host 30 need not be modified in any way to be operationally coupled to data storage device 10. Data storage device 10 appears to the operating system of host 30 as a standard data storage device that lacks special data rights management/protection functionality.

When data storage device 10 is connected operationally to host 30, host 30 reads file system 24 to determine how files 20a through 20n are stored in memory 12, so that applications running on host 30 can know the identities of the blocks of memory 12 in which files 20a through 20n are stored. (If memory 12 is a flash memory then its blocks are identified by logical block number rather than by physical block number, as is known in the prior art.) The applications running on host 30 issue block read commands to read the data in the various blocks. A monitoring module 15 of access control functionality 16 monitors these read commands. If read commands for accessing data of a file 20 are not in accordance with the access profile 22 of that file 20, a response module 17 of access control functionality 16 takes appropriate action.

Like the rest of controller 14, access control functionality 17 generally, and monitoring module 15 and response module 17 in particular, may be implemented in hardware, in firmware or in software.

Each access profile 22 describes limits of normal accesses of the associated file 20 by applications that access that file 20 for the purposes for which that file 20 was created. Typical examples of such access profiles, for an audiovisual file and for a database file, and how access control functionality 16 enforces these access profiles, now will be presented.

Audiovisual File

Normally, the blocks of an audiovisual file are read sequentially. The first several blocks are read as fast as host 30 can copy the blocks, in order to fill a buffer in host 30. Subsequently, the blocks are read more slowly, only as fast as host 30 can display the blocks to the user. The corresponding access profile is an access rate schedule that defines a sequence of minimum times that must elapse between successive block read commands. If data storage device 10 receives block read commands faster than allowed by this rate schedule (as measured e.g. by counting how many blocks data storage device 10 sends to host 30 per unit time), response module 17 of access control functionality 16 takes one or more of the following defensive actions:

Refuse to honor the block read commands. Stop sending data to host 30.

Issue an error message.

Issue a report of an attempt to copy protected data. For example, if host 30 is a cellular telephone, issue an SMS message to the owner of the audiovisual file.

Send spurious data to host 30 instead of real data.

A hacker can fool this access profile by coding a copy application that emulates an audiovisual player application by issuing block read commands only at the rate that an audiovisual player application would issue such commands. But then the hacker would copy the file at the slow play speed of the file, for example 90 minutes for a 90 minute movie.

Database File

Normally, the blocks of a database file are read sporadically and piecewise sequentially. The corresponding access profile includes a maximum number of blocks that are allowed to be read without a pause of pre-defined minimum duration and/or a maximum number of blocks that are allowed to be read sequentially. Any attempt by host 30 to read more than that number of blocks sequentially is countered by one or more of the following defensive actions:

Refuse to honor the block read commands. Stop sending data to host 30.

Issue an error message.

Issue a report of an attempt to copy protected data. For example, if host 30 is a cellular telephone, issue an SMS message to the owner of the database.

Send spurious data to host 30 instead of real data.

In addition, if the owner of the database also is the owner of the database application, the owner can code the database application to always ignore certain blocks. The access profile then includes the identities of these spurious blocks, or equivalently the identities of the legitimate blocks, for example as the logical numbers (e.g. relative to the first block of the file) of these spurious blocks or of the legitimate blocks. If host 30 attempts to read a spurious block, access control functionality 16 takes one or more of the defensive actions listed above. For example, host 30 could be sent spurious data simply by loading the blocks designated as spurious with all 0's, all 1's or random bits.

Some access profiles are easy to determine a priori. For example, the rate schedule of an audiovisual file can be predicted in advance, on the basis of the largest buffer that host 30 is likely to have and on the basis of how fast host 30 needs to display successive blocks of the audiovisual file. Other access profiles need to be learned empirically. For example, it is difficult to predict in advance the largest number of blocks of a database file that will be read sequentially in normal use. For example, the owner of both the database and the database application can learn the normal access pattern of the database by monitoring use of the database during beta-testing of the database application by friendly users.

Memory 12 is shown as having stored therein one more file 44, of encrypted data. File 44 includes its own access profile 42. File system 24 presents file 44 to host 30 as a virtual clear file 40 that has the same name as file 44 but may or may not have the same filename extension, so that, optionally, host 30 may or may not be aware of the existence of file 44. For example, if the data in file 44 are audiovisual data, virtual file 40 could be given a filename extension such as “mp4” that is appropriate to audiovisual data while encrypted file 44 is given a filename extension such as “mxx” to indicate to controller 14 that file 44 is an encrypted file. When host 30 starts to access file 40, controller 14 decrypts the requested blocks of file 44 using decryption functionality 26 and sends the decrypted blocks to host 30, while using access control functionality 16 to monitor the access of the blocks by host 30 relative to access profile 42. If monitoring module 15 of access control functionality 16 determines that the accessing of file 40 by host 30 deviates from access profile 40, response module 17 of access control functionality 16 takes one or more of the defensive actions listed above.

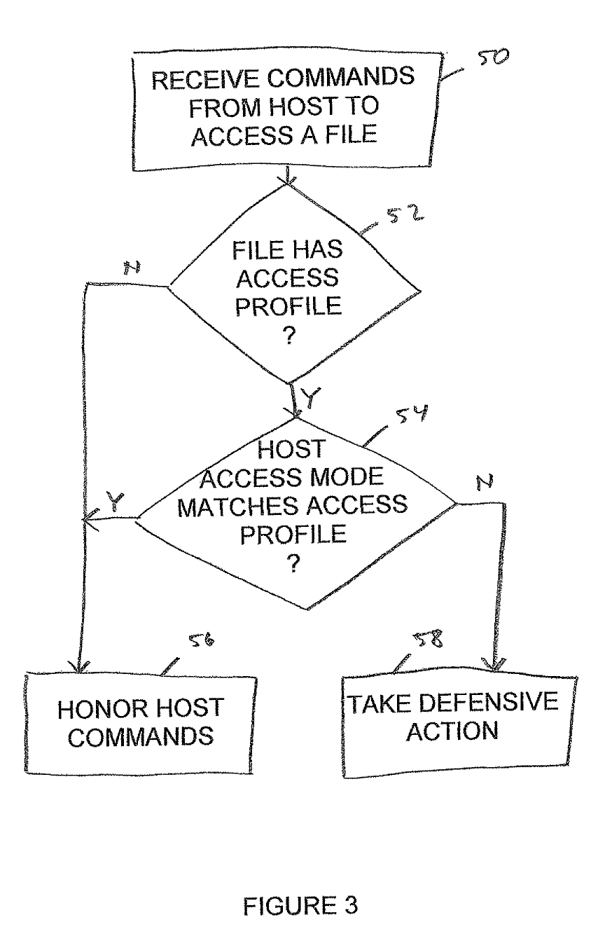

FIG. 3 is a generalized flowchart of a method of digital rights protection. In block 50, data storage device 10 receives commands from host 30 to access a file that is stored in memory 12. If the file does not have an access profile associated with it (block 52), data storage device 10 honors the host commands (block 56). If the file does have an access profile associated with it (block 52), monitoring module 15 of access control functionality 16 of controller 14 monitors the commands to determine whether the attempt of host 30 to access the file is in accordance with the file's access profile (block 54). If the attempt of host 30 to access the file is in accordance with the file's access profile, data storage device 10 honors the host commands (block 56). Otherwise, data storage device 10 takes defensive action (block 58) as described above.

A limited number of embodiments of a method, device and system for digital rights protection have been described. It will be appreciated that many variations, modifications and other applications of the method, device and system may be made.

What is claimed is:

1. A method of providing data stored in a memory to a host of the memory, comprising the steps of:
(a) monitoring an access, by the host, of data stored in the memory, said data having a dynamic access profile associated therewith; and
(b) responding to a deviation of said access from said dynamic access profile.

2. The method of claim 1, wherein said responding includes terminating said access.

3. The method of claim 1, wherein said responding includes issuing a report of said deviation.

4. The method of claim 1, wherein said responding includes sending spurious data to the host.

5. The method of claim 1, further comprising the step of:
(c) providing said dynamic access profile.

6. The method of claim 5, wherein said providing includes learning a normal access pattern of the data.

7. The method of claim 1, wherein said dynamic access profile includes a rate schedule of access of the data by the host.

8. The method of claim 1, wherein said dynamic access profile includes a sequence of access of the data by the host.

9. The method of claim 1, wherein said dynamic access profile includes an identity of the data.

10. A data storage device for providing data to a host, comprising:
(a) a memory wherein the data are stored together with a corresponding data access profile; and
(b) an access control mechanism for
(i) monitoring an access by the host to said memory; and
(ii) responding to a deviation of said access from said dynamic access profile.

11. The data storage device of claim 10, wherein said responding includes terminating said access.

12. The data storage device of claim 10, wherein said responding includes issuing a report of said deviation.

13. The data storage device of claim 10, wherein said responding includes sending spurious data to the host.

14. The data storage device of claim 10, wherein said dynamic access profile includes a rate schedule of access of the data by the host.

15. The data storage device of claim 10, wherein said dynamic access profile includes a sequence of access of the data by the host.

16. The data storage device of claim 10, wherein said dynamic access profile includes an identity of the data.

17. The data storage device of claim 10, further comprising:
(c) a standard interface to the host.
